(19) United States
(12) Patent Application Publication
(10) Pub. No.: US 2024/0272905 A1
(43) Pub. Date: Aug. 15, 2024

(54) ACCESS REQUEST DYNAMIC MULTILEVEL ARBITRATION

(71) Applicant: Akeana, Inc., San Jose, CA (US)

(72) Inventor: Sanjay Patel, San Ramon, CA (US)

(73) Assignee: Akeana, Inc., San Jose, CA (US)

(21) Appl. No.: 18/437,281

(22) Filed: Feb. 9, 2024

Related U.S. Application Data
(60) Provisional application No. 63/605,620, filed on Dec. 4, 2023.
(60) Provisional application No. 63/602,514, filed on Nov. 24, 2023.
(60) Provisional application No. 63/547,574, filed on Nov. 7, 2023.
(60) Provisional application No. 63/547,404, filed on Nov. 6, 2023.
(60) Provisional application No. 63/546,769, filed on Nov. 1, 2023.
(60) Provisional application No. 63/545,961, filed on Oct. 27, 2023.
(60) Provisional application No. 63/542,797, filed on Oct. 6, 2023.
(60) Provisional application No. 63/526,009, filed on Jul. 11, 2023.
(60) Provisional application No. 63/521,365, filed on Jun. 16, 2023.
(60) Provisional application No. 63/471,283, filed on Jun. 6, 2023.
(60) Provisional application No. 63/467,335, filed on May 18, 2023.
(60) Provisional application No. 63/463,371, filed on May 2, 2023.
(60) Provisional application No. 63/462,542, filed on Apr. 28, 2023.
(60) Provisional application No. 63/444,619, filed on Feb. 10, 2023.

(51) Int. Cl. G06F 9/30; G06F 15/80

(52) U.S. Cl. CPC G06F 9/30036; G06F 15/8069

(57) ABSTRACT

Techniques for processor request arbitration using access request dynamic multilevel arbitration are disclosed. A plurality of processor cores is accessed. The plurality of processor cores is coupled to a memory subsystem. A plurality of access requests is generated within the processor cores coupled to the memory subsystem. The plurality of access requests is generated by the plurality of processor cores. Multiple access requests are made in a single processor cycle. Only one access request is serviced in a single processor cycle. A set of at least two criteria is associated to each access request in the plurality of access requests criteria which are dynamically assigned. The requests are organized in two vectors and a stack. The vectors are organized as linear vectors. The stack is organized as a push-pop stack. The request is granted, based on data in the two vectors and the stack.

### RELATED APPLICATIONS

This application claims the benefit of U.S. provisional patent applications “Access Request Dynamic Multilevel Arbitration” Ser. No. 63/444,619, filed Feb. 10, 2023, “Processor Pipeline For Data Transfer Operations” Ser. No. 63/462,542, filed Apr. 28, 2023, “Out-Of-Order Unit Stride Data Prefetcher With Scoreboarding” Ser. No. 63/463,371, filed May 2, 2023, “Architectural Reduction Of Voltage And Clock Attach Windows” Ser. No. 63/467,335, filed May 18, 2023, “Coherent Hierarchical Cache Line Tracking” Ser. No. 63/471,283, filed Jun. 6, 2023, “Direct Cache Transfer With Shared Cache Lines” Ser. No. 63/521,365, filed Jun. 16, 2023, “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, and “Cache Snoop Replay Management” Ser. No. 63/605,620, filed Dec. 4, 2023.

Each of the foregoing applications is hereby incorporated by reference in its entirety.

### FIELD OF ART

This application relates generally to processor request arbitration and more particularly to access request dynamic multilevel arbitration.

### BACKGROUND

Integrated circuits or “chips” are now commonly found in what seems like every imaginable appliance, tool, gadget, and more. Household and kitchen appliances, personal computers, handheld electronic devices, medical equipment, smartwatches, toys, and vehicles, among many other products, contain at least one integrated circuit. Designing and building products containing integrated circuits has become so prevalent that changes in consumer demand for given products or interruptions of integrated circuit manufacturing have caused massive supply issues. Parts and labor shortages, retooling challenges, and transportation woes have all contributed to the supply problems. In recent history, as manufacturers of some products saw a reduction in demand for their products, they released chip manufacturing schedules which were immediately picked up by other manufacturers who required different chips. Then, when demand again picked up, limited or no chip manufacturing capacity was available to the first manufacturers for weeks or even months. Thus, the integrated circuits that have become so deeply embedded in products play significant roles in product pricing and availability of those products.

Integrated circuits are critical to electronic devices such as smartphones, tablets, televisions, laptop computers and desktop computers, gaming consoles, and more. Device features and utility directly derive from the chips. These features greatly enhance device usefulness and utility. Device features that were once only dreamed of are now widely considered essential. Toys and board games have not escaped the chip revolution. The toys and games are enhanced by interactive play which is driven by increasingly sophisticated AI. The toys and games can entertain small children, first time game players, and experienced gamers with equal effectiveness. Play and gaming is further enhanced by stunningly realistic, holographic audio and brilliant graphics, enabling players to enjoy an immersive play and gaming experience. The games support single participant and team play, encouraging players to join together to participate. The chip-enhanced games can even enable players to join the fun from locations around the world. The players can equip themselves with virtual reality headsets that enable players to be immersed in virtual worlds, surrounded by computer generated graphics and 3D audio. Vehicular applications of integrated circuits are also ever expanding. Increasing numbers of chips can be used to enable new features. The chips improve vehicle operating efficiency, vehicle safety, cabin climate control, and entertainment. The integrated circuits are found in vehicles including manually operated, semiautonomous, and autonomous vehicles. Vehicle safety features include proximity to other vehicles, out of lane operation, and even driver status.

### SUMMARY

The inclusion of integrated circuits or “chips” in all manner of devices is nearly ubiquitous. The chips frequently include a processor which can be used for control of a device and to enable a wide variety of features. Many household appliances, personal computers, handheld electronic devices, medical equipment components, smartwatches, toys, and vehicles, among many other common or familiar devices, contain at least one processor. The chips are used to enable device features, to execute apps and other codes, and to provide the device user with features and capabilities that were previously unobtainable. The features and capabilities can include cellular and internet telephony, music and video streaming, and news and sports updates, to name only a very few. Apps can be executed by the processors that enable navigation by car, by bicycle, on foot, or using public transportation. Further apps can couple to a wearable device to monitor blood pressure, blood oxygen saturation, blood sugar levels, and more. Processors within the chips are typically coupled to additional elements that support the processors. The additional elements typically include one or more of shared, common memories, communications channels such as networks and radios, peripherals such as touchscreens, and so on.

Performance of a processor can be greatly enhanced by providing a local copy of data to the processor. The copy can be loaded into a cache memory, where the cache memory can be coupled to one or more processors. The cache memory is typically small in comparison to a memory subsystem shared by a plurality of processors, but the cache memory provides the performance boost because of greatly reduced access time to the cache memory in comparison to the memory subsystem. Accessing the contents of the cache works because of the “locality” of instructions and data. That is, blocks of instructions can be executed sequentially, data to be processed can be processed sequentially, etc. The locality of the instructions and the data enables blocks of instructions and data to be moved from the memory subsystem to the cache memory. The processor executes instructions and processes data in the cache. When the contents of the cache “run out”, a cache miss occurs, and the contents of the cache can be updated from the shared memory. Changed data within the cache can be written to the shared memory, new instructions and data can be read, and so on.

Processor request arbitration is enabled by access request dynamic multilevel arbitration. A plurality of processor cores is accessed. The plurality of processor cores is coupled to a memory subsystem. A plurality of access requests is generated within the processor cores coupled to the memory subsystem. The plurality of access requests is generated by the plurality of processor cores. Multiple access requests are made in a single processor cycle. Only one access request is serviced in a single processor cycle. A set of at least two criteria is associated to each access request in the plurality of access requests criteria, and is dynamically assigned. The requests are organized in two vectors and a stack. The vectors are organized as linear vectors. The first criteria can include that an active request is present. The stack is organized as a push-pop stack. The purpose of the push-pop stack is to organize requests in time such that the arbitration logic can prioritize requests which are now “ready” based on a second criterion, such as the second criterion of the data for the request being ready. The request is granted, based on data in the two vectors and the stack. Access request history comprises a first criterion. A second criterion enables the granting a request. A second criterion of the at least two criteria is a “data ready” criterion. If more than one active request (first criterion) is “data ready” (second criterion), then the older active request is selected, based on the order contained in the push-pop stack.

A processor-implemented method for request arbitration is disclosed comprising: accessing a plurality of processor cores, wherein the plurality of processor cores is coupled to a memory subsystem; generating a plurality of access requests, within the processor cores coupled to the memory subsystem, by the plurality of processor cores; associating a set of at least two criteria to each access request in the plurality of access requests, wherein the criteria are dynamically assigned; organizing the requests in two vectors and a stack; and granting a request, based on data in the two vectors and the stack. A stack such as a push-pop stack can also be used for the memory access request arbitration. The push-pop stack can be loaded with memory access requests, where the oldest memory access request is at the bottom of the stack and the newest memory access request is at the top of the stack. The push-pop stack can be scanned from top to bottom to identify dependencies between memory access requests. Access dependencies can cause memory access hazards if the requests are not granted in the appropriate order. The memory access requests can result from a cache miss. The granting a request can result in a cache line fill for a cache miss.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for access request dynamic multilevel arbitration.

FIG. 2 is a flow diagram for vector and stack usage.

FIG. 3 is a system block diagram showing dynamic multilevel arbitration.

FIG. 4 is a block diagram illustrating a RISC-V processor.

FIG. 5 is a block diagram for a pipeline.

FIG. 6 is a system block diagram illustrating processor cores with processor request arbitration.

FIG. 7 is a system diagram for access request dynamic multilevel arbitration.

### DETAILED DESCRIPTION

Techniques for processor request arbitration using access request dynamic multilevel arbitration are disclosed. A processor such as a standalone processor, a processor chip, a processor core, and so on can be used to perform data processing tasks. The data processing tasks can include image and audio processing, accounts payable and receivable processing, artificial intelligence, virtual reality, and so on. The processing of data can be significantly enhanced by using two or more processors to process the data. The processors can be performing substantially similar operations, where the processors can process different portions or blocks of data in parallel. The blocks of data can comprise one or more cache lines. The processors can be performing substantially different operations, where the processors can process different blocks of data or may perform different operations on the same data. Irrespective of whether the operations performed by the processors are substantially similar or not, managing how access requests are granted for the processors, and determining whether the data to be accessed is unprocessed or processed (e.g., clean or “dirty”), are critical components to successfully processing the data. Processing stale or dirty data produces incorrect results. Further, since two or more processors can be processing data at substantially the same time, the data that is processed must remain coherent between a primary copy of the data in main memory or memory subsystem and all copies of the data which can be loaded into caches local to the processors.

A cache memory can be used to store a local or easily accessible copy of the data to be processed. Access times to the local cache memory are substantially lower than access time to a shared memory, thereby increasing the speed of operations such as data processing operations associated with large data sets or large numbers of similar processing jobs. A cache memory, which is typically smaller and faster than a shared, common memory, can be coupled between the common memory and the processors. As the processors process data, they search first for an address containing the requested data within the cache memory. If the address is not present within the cache, then a “cache miss” occurs, and the data requested by the processors can be obtained from an address within the common memory. Use of the cache memory for data access by one or more processors is preferable to accessing shared memory because of reduced latency associated with accessing the small, fast cache memory as opposed to accessing the large, slow (in comparison) common memory. The accessing data within the cache is further enhanced due to the “locality of reference”. That is, code, as it is being executed, tends to access a substantially similar set of memory addresses, whether the memory addresses are located in the common memory or the cache memory. By loading the contents of a set of common memory addresses into the cache, the processors are more likely to find the requested data within the cache and can obtain the requested data faster than obtaining the requested data from the common memory. Due to the smaller size of the cache with respect to the common memory, a cache miss can occur when the requested memory address is not present within the cache. One cache replacement technique that can be implemented loads a new block of data from the common memory into the cache memory to accomplish a cache line fill. The new block contains the requested address. Thus, processing can again continue by accessing the faster cache rather than the slower common memory.

The processors can read data from a memory such as the cache memory, process the data, then write the processed data back to the cache. As a result of this read-modify-write technique, the contents of the local cache can be different from the contents of the common memory. To remedy this difference state so that the common memory and the cache memory are “in sync”, coherency management techniques can be used. The coherency techniques can ensure that data within the common memory can be updated or modified to reflect the data changes within the cache memory. Since more than one cache memory can be used, the updated data must also be reflected in all copies of the data from the shared memory. A similar problem can occur when out-of-date data remains in the cache after the contents of the common memory are updated. Again, this state can be remedied using coherency management techniques employing processor request arbitration. In embodiments, any additional local caches can be coupled to groupings of two or more processors. While the additional local caches can greatly increase processing speed, the additional caches further complicate coherency management since data differences can exist not only between a cache and the common memory but also between caches. Techniques presented herein can address processor request arbitration between common memory and the caches, and processor request arbitration among the caches based on using access request dynamic multilevel arbitration. The dynamic multilevel arbitration monitors memory access operations to determine whether a difference exists between data in the common memory and data in the one or more caches. If a difference exists, then one or more cache coherency management techniques can be applied.

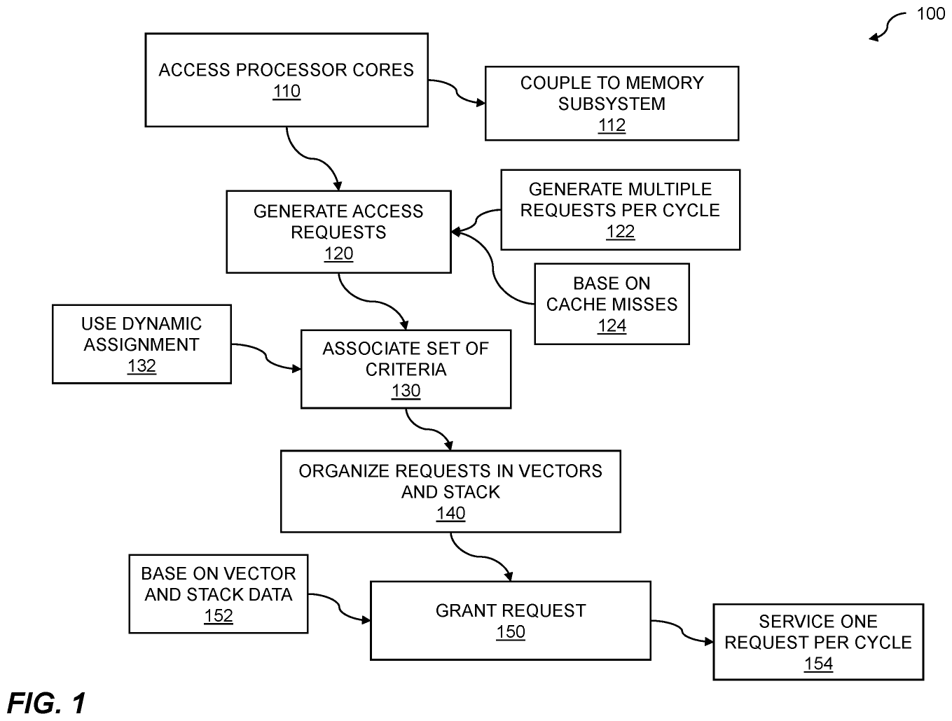

FIG. 1 is a flow diagram for access request dynamic multilevel arbitration. The dynamic multilevel arbitration can accomplish processor request arbitration between a memory subsystem shared by a plurality of processor cores and one or more local caches. One or more local caches can be coupled to one or more processor cores. The processor request arbitration can be applied to the shared memory, one or more local caches, a processor, one or more processor cores, and so on. A processor can include a multicore processor such as a RISC-V™ processor. The processor cores can include homogeneous processor cores or heterogeneous processor cores. The cores that are included can have substantially similar capabilities or substantially different capabilities. The processor cores can include or be coupled to further elements. The further elements can include one or more of physical memory protection (PMP) elements, memory management (MMU) elements, level 1 (L1) caches such as instruction caches and data caches, level 2 (L2) caches, and the like. The multicore processor can further include a level 3 (L3) cache, test and debug support such as Joint Test Action Group (JTAG) elements, a platform level interrupt controller (PLIC), an advanced core local interrupter (ACLINT), and so on. In addition to the elements just described, the multicore processor can include one or more interfaces. The interfaces can include one or more industry standard interfaces, interfaces specific to the multicore processor, and the like. In embodiments, the interfaces can include an Advanced eXtensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. The interfaces can enable connection between the multicore processor and an interconnect. In embodiments, the interconnect can include an AXI™ interconnect. The interconnect can enable the multicore processor to access a variety of peripherals such as storage elements, communications elements, etc.

The flow 100 includes accessing a plurality of processor cores 110. The processor cores can include homogeneous processor cores, heterogeneous processor cores, processor cores with varying processing capabilities, and so on. The cores can include general purpose cores, specialty cores, custom cores, and the like. In embodiments, the cores can be associated with a multicore processor such as a RISC-V™ processor. The cores can be included in one or more integrated circuits or “chips”, application-specific integrated circuits (ASICs), programmable gate arrays (PGAs), and the like. In the flow 100, the plurality of processor cores is coupled to a memory subsystem 112. The memory subsystem can include a shared memory, a common memory, and so on. The memory subsystem can include a cache memory, a multilevel cache memory, etc. The multilevel cache memory can include level 1 (L1), level 2 (L2), level 3 (L3) cache, and the like. The memory subsystem can include a multiport memory. The processor cores can be coupled to further storage. In further embodiments, each processor within the plurality of processor cores can be coupled to a dedicated local cache. The dedicated local cache can include a single-level cache, a multi-level cache, etc. In other embodiments, the dedicated local cache can be included in a coherency domain. The coherency domain can include the plurality of processors, the memory subsystem, the local caches, etc.

The flow 100 includes generating a plurality of access requests 120, to the memory subsystem, by the plurality of processor cores. The access requests can include various types of processor access requests, such as requests for resources including registers, requests for data, requests for memory access, and so on. Memory access requests can include read or load requests, write or store requests, and so on. The read operations can include read operations for a local cache, one or more shared caches, a shared memory, and so on. The write operations can write operations for one or more of a local cache, a shared cache, shared memory, etc. Other operations can be generated by the plurality of processor cores. In embodiments, the plurality of processor cores can generate read-modify-write operations. In the flow 100, multiple access requests are made in a single processor cycle 122. A processor within the plurality of processors can generate one or more access requests in a single processor cycle. Other processors within the plurality of processors can also generate one or more access requests. Memory access requests can be made to one or more memory addresses. The memory addresses can be within a local cache, a shared cache, the memory subsystem, etc. A memory access request can be generated to obtain data for processing, to process the data, to store processed data, and so on. In the flow 100, the access requests result from cache misses 124. Recall that blocks of data such as cache lines can be moved from a memory subsystem to a cache memory. The contents of the cache memory can be processed until data that is requested by a processor is not found within the cache. This “cache miss” indicates that in order to obtain the requested data, an access request can be made to the memory subsystem to obtain the requested data. In embodiments, only one access request can be serviced in a single processor cycle.

Discussed above, the memory subsystem can include a single port memory, a multiport memory, and the like. In embodiments, the shared memory structure can include a shared cache for the plurality of processor cores. The shared cache can include a small, fast, local memory that can be shared by processor cores. The shared cache can comprise a multi-level cache, where the levels can include level 1 (L1), level 2 (L2), level 3 (L3), and so on. Each succeeding level can be larger and slower than the previous level such that L2 can be larger and slower than L1, L3 can be larger and slower than L2, and so on. In embodiments, the shared memory structure can have data regions and instruction regions (e.g., Harvard Class architecture). The data regions and instruction regions can include regions that are physically separated, logically separated, etc. The shared memory structure can be accessible to the plurality of processor cores through an interconnect or a network, a bus, an interface element, etc. The interface element can support standard processor interfaces such as an Advanced eXtensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. The interface elements can be coupled to the interconnect. The interconnect can include a bus, a network, and so on. The interconnect can include an AXI™ interconnect. In embodiments, the network can include network-on-chip functionality, where the network-on-chip functionality can include coherent network-on-chip functionality. The coherent network-on-chip can include coherency messaging (e.g., cache coherency transactions) and cache miss requests.

The flow 100 includes associating a set of at least two criteria 130 to each access request in the plurality of access requests. The criteria can be used to describe the access requests, sort requests, enable or grant requests, memory requests, and so on. Described above, a plurality of access requests can be generated by the plurality of processor cores. A history can be associated with the access requests, where the history can include an order in which the access requests were generated, priority of one or more requests, precedence of one or more requests, and so on. In embodiments, access request history can comprise a first criterion. Discussed below, the access request history can be used to organize access requests. The organizing can include ordering the requests, prioritizing the requests, and so on. In other embodiments, a first criterion of the at least two criteria can be an age-based criterion. The age-based criterion can be used to determine an order of execution of access requests. In further embodiments, a second criterion of the at least two criteria can be a “data ready” criterion. The data ready criterion can be used to indicate that data is ready to be read, ready to be processed, ready to be written, and so on. In embodiments, “data ready” can indicate that resultant data for a particular access request is available. Since more than one processor can be used to process data, and because the order of execution of various processing tasks can be dictated by a code being executed by a processor, then an access request can be dependent on completion of another memory access task. In a usage example, a processor can execute a read-modify-write operation. The result of the read-modify-write operation can be used by a second read-modify-write operation. Thus, the second read-modify-write operation must wait for the first read-modify-write operation to complete or else invalid data would be used for the second operation. In the flow 100, the criteria are dynamically assigned 132. The dynamic assignment can include assigning one or more criteria as an access request is received. The assignment can be dynamically updated based on receiving further access requests, examining earlier access requests for dependencies, and the like.

The flow 100 includes organizing the requests 140 in two vectors and a stack. The two vectors and the stack can be used to hold access requests, criteria, and so on. In embodiments, the vectors can be organized as linear vectors. The linear vectors can be expanded as more access requests are received, contracted and access requests are granted, etc. The linear vectors can be organized, reordered, and the like. In embodiments, the first linear vector can contain access request inputs. The access request inputs can include the access requests generated by the plurality of processor cores. The access requests can be added to the first linear vector in the order in which the requests are received. In embodiments, a first criterion is used to organize the first linear vector. Discussed previously and throughout, the ordering can include an order in which the access requests were received, an execution order, etc. In embodiments, a second linear vector contains a second criterion. The second criterion can include a tag, a label, etc. In embodiments, the second criterion can enable the granting a request (discussed below).

In embodiments, the stack associated with the organizing can be organized as a push-pop stack. A push-pop stack, or “last-in first-out” stack, receives data and “pushes data” onto the stack. Data is removed from the stack by “popping” the data from the stack. In embodiments, the push-pop stack can contain indices into the first linear vector. The indices can reference the access requests in the first linear vector. The indices can include one or more of an address, relative address, pointer, offset, and the like. In embodiments, an oldest access request can be at the bottom of the push-pop stack. The oldest access request can include the first access request pushed onto the push-pop stack. In other embodiments, a newest access request can be at the top of the push-pop stack. The newest access request can include the most recent access request generated by the plurality of processor cores. In embodiments, the push-pop stack data comprises multilevel arbitration criteria.

The flow 100 includes granting a request 150, based on data in the two vectors and the stack. The granting a request enables the access request to proceed. The granting the access request can be based on the request being the next request in the first linear vector, can occur after determining that data dependencies associated with the access request have been satisfied, and so on. In the flow 100, the granting a request can be based on data 152 within the first linear vector, the second linear vector, and the push-pop stack. The data can be examined to determine an order for granting an access request. In embodiments, the push-pop stack can be scanned from top to bottom. This “newest” request to “oldest” request can be used to determine data dependencies associated with, for example, memory addresses accessed at various times by one or more processor cores. Discussed throughout, an amount of data can be retrieved by an access request. The amount of data can include a block, a cache line, and so on. In embodiments, the granting a request can result in a cache line fill for a cache miss. In the flow 100, only one access request is serviced in a single processor cycle 154. The servicing only one request per cycle reduces memory access contention, reduces memory access hazards such as reading before write and writing before read, etc.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

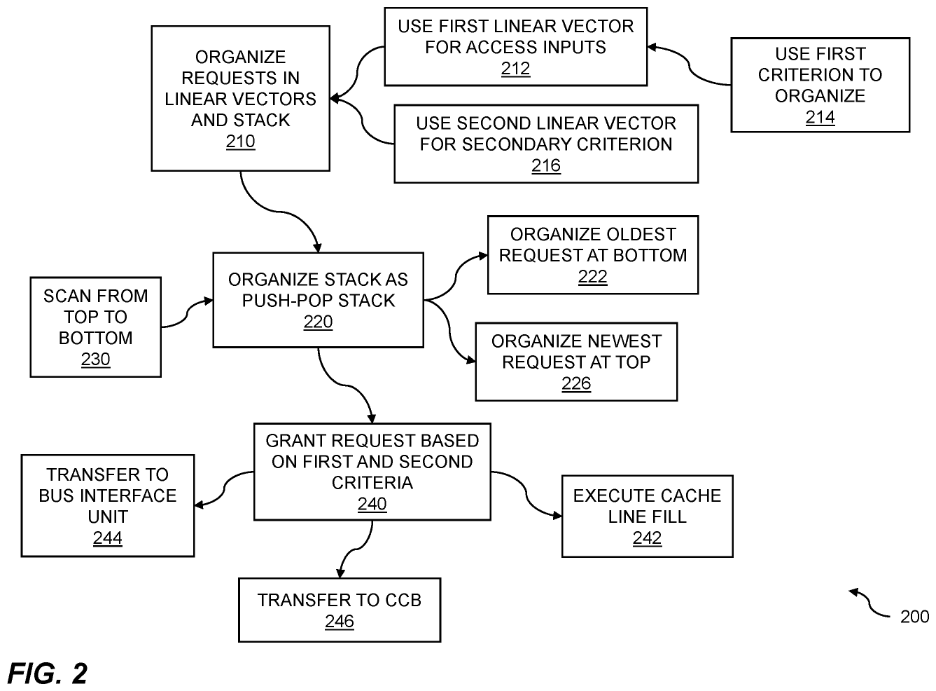

FIG. 2 is a flow diagram for vector and stack usage. Access requests can be generated by processor cores within a plurality of processor cores. Access requests can be organized within two vectors and a stack. The organizing the access requests into the vectors and the stack enables access request dynamic multilevel arbitration. A plurality of processor cores is accessed, wherein the plurality of processor cores is coupled to a memory subsystem. A plurality of access requests is generated, within the plurality of processor cores coupled to the memory subsystem, by the plurality of processor cores. A set of at least two criteria is associated to each access request in the plurality of access requests, wherein the criteria are dynamically assigned. The requests are organized in two vectors and a stack. The request is granted, based on data in the two vectors and the stack.

The flow 200 includes organizing access requests 210 in two vectors and a stack. The access requests can be generated by the plurality of processor cores. The access requests can be made to a memory subsystem. In embodiments, the vectors can be organized as linear vectors. The linear vectors can be used to store access requests, to manipulate the requests, to store criteria associated with the access requests, and so on. In the flow 200, a first linear vector contains access request inputs 212. An access request input can include a read or load request, a write or store request, and so on. The requests can include requests to a local cache, a shared cache such as a multilevel cache, a common memory such as the shared memory subsystem, and the like. In addition to the access request inputs, an access request history can be maintained. The access request history can include an order in which the access requests were received. In embodiments, access request history comprises a first criterion. In the flow 200, a first criterion is used to organize 214 the first linear vector. The organizing the first linear vector can be based on an order in which access requests are received; priority, precedence, and dependencies on other access requests; etc. A second criterion can be associated with the access requests. In the flow 200, a second linear vector contains a secondary criterion 216. The second criterion can provide additional information about access requests, can enable the requests or hold the requests, and so on. In embodiments, the second criterion can enable the granting a request (discussed below). The second criterion can grant an access request using a variety of techniques. In embodiments, the second criterion of the at least two criteria can be a “data ready” criterion. The data ready criterion can indicate that valid data is available for reading, data can be safely written without overwriting valid data, etc.

In the flow 200, the stack associated with organizing the access requests can be organized 220 as a push-pop stack. In a push-pop stack, new access requests are “pushed” onto the top of the stack while older access requests are pushed down. The most recent access requests are “popped” from the top of the stack. The push-pop stack can be based on a last-in-first-out technique. The push-pop stack can contain a variety of information associated with the access requests. In embodiments, the push-pop stack can contain indices into the first linear vector. The indices can include pointers, offsets, relative addresses, and the like. In the flow 200, an oldest access request can be at the bottom 222 of the push-pop stack. Since the oldest request can be the access request first pushed onto the push-pop stack, then the access request can be at the “bottom” of the stack. The oldest request can be the first request generated by a processor core within the plurality of processor cores. In the flow 200, a newest access request can be at the top 226 of the push-pop stack. The newest access request can be the most recent, last, etc. request generated by a processor core within the plurality of processor cores. In the flow 200, the push-pop stack can be scanned from top to bottom 230. By scanning from top to bottom 230 within the push-pop stack, dependencies between and among access requests can be identified. In a usage example, an access request can be the next request to be granted. By scanning from top to bottom in the stack, any “older” access requests that can access the same storage location can be identified. The older access requests can be examined for where the older request will change data contents needed by the newer request. If determined to be necessary, coherency management can be performed to ensure that the proper data is accessed. The accessing can include reading or writing data.

One or more of the plurality of access requests generated by the plurality of processor cores can be granted. The flow 200 includes granting the access request, based on data in the two vectors and the stack 240. The data in the two vectors and the stack are based on the first criterion and the second criterion. Recall that the access request history comprises a first criterion. The access request history includes an order in which access requests were received. The first criteria can include that an active request is present. The stack is organized as a push-pop stack. The purpose of the push-pop stack is to organize requests in time such that the arbitration logic can prioritize requests which are now “ready” based on a second criterion, such as the second criterion of the data for the request being ready. The request is granted, based on data in the two vectors and the stack. Access request history comprises a first criterion. A second criterion enables the granting a request. A second criterion of the at least two criteria is a “data ready” criterion. If more than one active request (first criterion) is “data ready” (second criterion), then the older active request is selected, based on the order contained in the push-pop stack.

In embodiments, the second criterion enables the granting a request. The granting a request can be based on the second criterion providing an indication of “data ready”. The data ready criterion can be used to ameliorate memory access hazards such as read before write, write before read, and so on. In embodiments, “data ready” can indicate when resultant data for a particular access request is available. Recall that an access request to the memory subsystem can result from a cache miss. A cache miss can occur when a processor core attempts to access data that is not in a local cache, the data in the local cache is “stale” or out of date (e.g., incoherent with respect to the memory subsystem), and the like. In the flow 200, the granting a request results in a cache line fill 242 for a cache miss. The cache line fill can be accomplished by the compute coherency block with data obtained from the memory subsystem.

The flow 200 includes transferring cache lines between a processor cache in a compute coherency block (CCB) and storage in a bus interface unit (BIU) 244 (for writes to memory) or between the BIU storage and a CCB processor cache 246 (for reads from memory, including cache fills). The transferring can be based on a number of bits, bytes, words, and so on. The transferring can be based on a cache line width. In embodiments, the cache line comprises 512 bits. In embodiments, the transfer to CCB 246 comprises executing a cache line fill 242. The transferring can include transferring from the arbitration storage within a compute coherency block (CCB) to a storage block within the bus interface unit. In embodiments, the CCB comprises a common ordering point for coherency management. The common ordering point can be used to maintain coherency between the shared memory and the one or more local queues. In embodiments, cache lines can be stored in a bus interface unit cache prior to commitment of the cache lines to the shared memory subsystem. Committing a cache line to the shared memory subsystem can be based on order of operation execution, operation precedence, operation priority, etc. In the flow 200, cache lines can be stored in a bus interface unit cache pending a cache line fill or transfer from the shared memory subsystem to the local cache. The local cache can include one or more local caches, where a local cache can be coupled to one or more processor cores. In embodiments, the transferring can be based on a response from one or more coherency maintenance operations. The coherency maintenance operations can include one or more snoop operations, one or more snoop responses, and so on. In embodiments, the transferring can be initiated based on a response to the snoops. When responses from one or more snoop operations are received, the transferring can be initiated. In embodiments, the transferring can occur from the CCB to the BIU and from the BIU to the CCB. In embodiments, the transferring can occur from a linear vector to the bus interface unit when a cache line is an evicted cache line. An evicted cache line can include “dirty” data which can be sent to the shared memory subsystem to update the contents of the shared memory subsystem. In embodiments, the evicted cache lines can be transferred to the bus interface unit, based on a successful snoop response. In other embodiments, the transferring can occur from the bus interface unit to the compute coherency block when the cache line is a pending cache line fill. The cache line fill can result from a memory access operation cache miss. In embodiments, cache lines in the bus interface unit can be transferred to the CCB, based on a successful snoop response.

As discussed later, maintaining cache coherency can be accomplished using cache maintenance operations, which can include cache block operations. A cache block can include a portion or block of common memory contents, where the block can be moved from the common memory into a local cache. In embodiments, the cache block operations can include a cache line zeroing operation, a cache line cleaning operation, a cache line flushing operation, and a cache line invalidating operation. These operations are discussed in detail below. The cache block operations can be used to maintain coherency. In embodiments, the cache line zeroing operation can include uniquely allocating a cache line at a given physical address with a zero value. The zero value can be used to overwrite and thereby clear previous data. The zero value can indicate a reset value. The cache line can be set to a nonzero value if appropriate. In embodiments, the cache line cleaning operation can include making all copies of a cache line at a given physical address consistent with that of memory. Recall that the processors can be arranged in groupings of two or more processors and that each grouping can be coupled to a local cache. One or more of the local caches can contain a copy of the cache line. The line cleaning operation can set or make all copies of the cache line consistent with the shared memory contents. In other embodiments, the cache line flushing operation can include flushing any dirty data for a cache line at a given physical address to memory and then invalidating any and all copies. The “dirty” data can result from processing a local copy of data within a local cache. The data within the local cache can be written to the common memory to update the contents of the physical address in the common memory. In further embodiments, the cache line invalidating operation can include invalidating any and all copies of a cache line at a given physical address without flushing dirty data. Having flushed data from a local cache to update the data at a corresponding location or physical address in the common memory, all remaining copies of the old data within other local caches becomes invalid.

The cache line instructions just described can be mapped to standard operations or transactions for cache maintenance, where the standard transactions can be associated with a given processor type. In embodiments, the processor type can include a RISC-V™ processor core. The standard cache maintenance transactions can differ when transactions occur from the cores and when transactions occur to the cores. The transactions can comprise a subset of cache maintenance operations, transactions, and so on. The subset of operations can be referred to as cache block operations (CBOs). The cache block operations can be mapped to standard transactions associated with an ARM™ Advanced eXtensible Interface (AXI™) Coherence Extensions (ACE™) interface, an Advanced Microcontroller Bus Architecture (AMBA™) Coherence Hub Interface (CHI™), etc. In embodiments, the cache coherency transactions can be issued globally before being issued locally. A globally issued transaction can include a transaction that enables cache coherency from a core to cores globally. The issuing cache coherency transactions globally can prevent invalid data from being processed by processor cores using local, outdated copies of the data. The issuing cache coherency transactions locally can maintain coherency within compute coherency blocks (CCBs) such as groupings of processors. In embodiments, the cache coherency transactions that are issued globally can complete before cache coherency transactions are issued locally. A variety of indicators, such as a flag, a semaphore, a message, a code, and the like, can be used to signify completion. In embodiments, an indication of completeness can include a response from the coherent network-on-chip.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

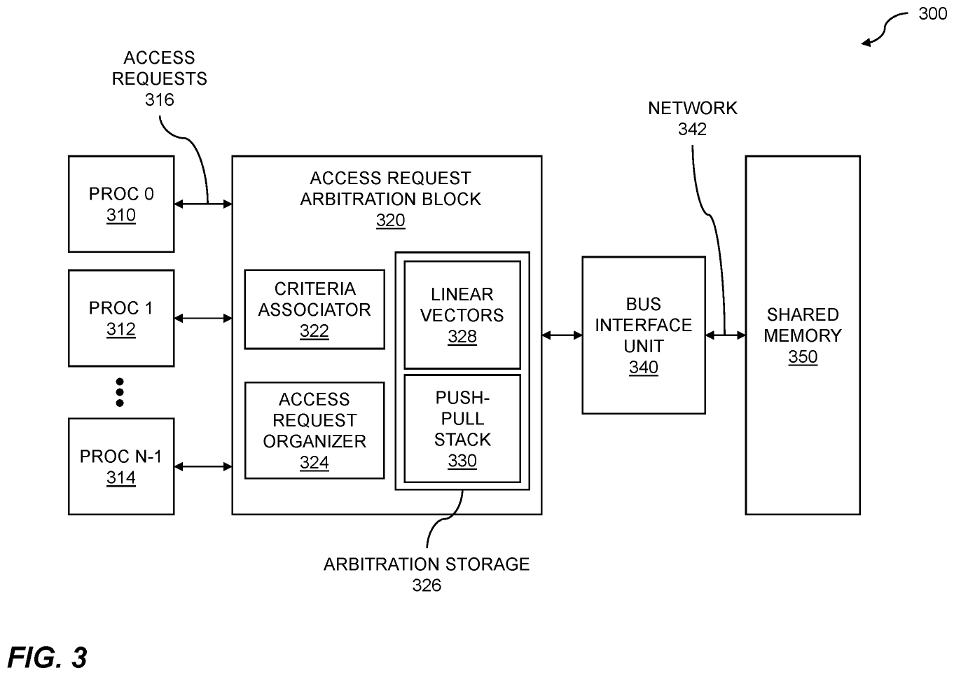

FIG. 3 is a system block diagram showing dynamic multilevel arbitration. The dynamic multilevel arbitration enables techniques for processor request arbitration. One or more processors such as multicore processors can access a shared, common memory. Processor cores can be coupled to a local cache, where the local cache can be colocated with the processor cores, adjacent to the processor cores, and so on. The local cache can be loaded with data from a source such as the shared, common memory. The processors coupled to the local cache can process the data. Processing the data in the local cache can cause the data to become “dirty” or different from the contents of the shared memory. Noted throughout, processor cores and groupings of processor cores can be coupled to their own local caches, and the processor cores can make changes to local cache data. Thus, the problem of maintaining coherency between the contents of the shared memory and the local caches becomes highly complex. To resolve the coherency challenges, access request dynamic multilevel arbitration techniques can be applied to memory access operations generated by the processor cores. The dynamic multilevel arbitration can organize access requests based on two or more criteria. A first criterion can include an age-based criterion. A second criterion can include a “data ready” criterion. Access requests can be granted based on data in two linear vectors and a stack.

The system block diagram 300 includes a plurality of processors such as processor 0 310, processor 1 312, processor N−1 314, and so on. The processors can include multicore processors such as a RISC-V™ processor. The processors can generate access requests 316. The access requests can be generated for a shared memory subsystem coupled to the plurality of processor cores. The access requests can be generated by any of the processor cores. The access requests can be captured by an access request arbitration block 320. The arbitration block can be responsible for dynamically managing arbitration of access requests. The arbitration block can perform arbitration for various processor-initiated requests, such as access requests including memory access requests.

In the system block diagram 300, the arbitration block 320 can include a criteria associator 322. The criteria associator can associate a set of at least two criteria to each access request in a plurality of access requests. The plurality of access requests can be generated by the plurality of processor cores. In embodiments, access request history can comprise a first criterion. The access request history can include an indication of when an access request was generated, by which processor core, to which memory location, and so on. In embodiments, a second criterion of the at least two criteria can be a “data ready” criterion. The data ready criterion can indicate that data is ready for reading or loading, writing or storing, and the like. In the system block diagram 300, the compute coherency block can include an access request organizer 324. The access request organizer can organize access requests into vectors and a stack. The access request organizer can organize arbitration storage 326. The arbitration storage can include two vectors 328 and a stack 330. In embodiments, the vectors can be organized as linear vectors. The vectors can contain one or more access requests or inputs. In embodiments, multiple access requests can be made in a single processor cycle. The multiple access requests can be generated by one or more processor cores within the plurality of processor cores. The access requests can be targeted to a shared memory. In embodiments, the stack can be organized as a push-pop stack. That is, the item most recently added to the stack is at the top of the stack, and the first item popped from the stack is that most recently added item. The stack can include pointers, indices, and so on. In embodiments, the push-pop stack can contain indices into the first linear vector.

The system block diagram 300 can include a bus interface unit 340. The bus interface unit can enable transferring data between the plurality of processor cores and a shared memory (discussed below), either utilizing the arbitration block for data flow or circumventing it. The bus interface can enable transferring of blocks of data. The transferring data can include transferring a cache line. The transferring can include evicted cache lines, where the evicted cache lines can include cache lines promoted for transfer to shared memory. The transferring can include cache lines read or loaded from shared memory pending cache line fill. The bus interface unit can be coupled to a network 342. The network can include an interconnect, a bus, and so on. In embodiments, the network can include a network-on-chip. The system block diagram 300 can include a shared memory structure 350. The shared memory structure can include a memory subsystem coupled to the plurality of processor cores. The shared memory structure can include memory colocated with the processor cores, adjacent to the processor cores, and so on. In embodiments, the processor cores can access the shared memory structure through an interconnect. The interconnect can include a bus, a network, and so on.

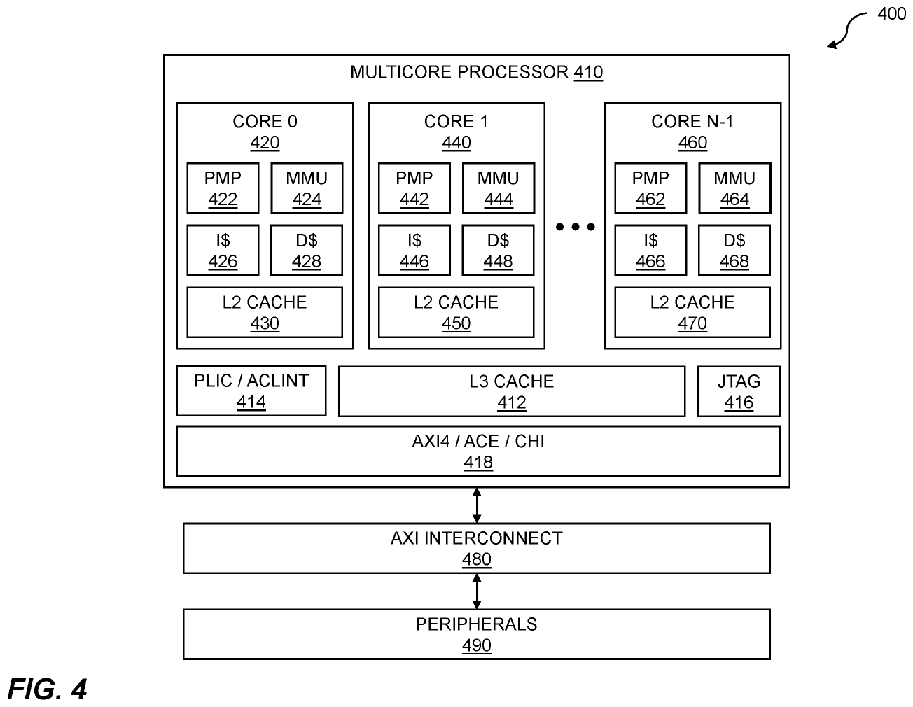

FIG. 4 is a block diagram illustrating a RISC-V™ processor. The processor can include a multi-core processor, where two or more processor cores can be associated with the processor. The processor, such as a RISC-V™ processor, can include a variety of elements. The elements can include processor cores, one or more caches, memory protection and management units, local storage, and so on. The elements of the multicore processor can further include one or more of a private cache, a test interface such as a Joint Test Action Group (JTAG) test interface, one or more interfaces to a network such as a network-on-chip, shared memory, peripherals, and the like. Processing by the multicore processor is enabled by processor request arbitration based on access request dynamic multilevel arbitration. A plurality of processor cores is accessed. The plurality of processor cores is coupled to a memory subsystem. A plurality of access requests is generated, within the plurality of processor cores coupled to the memory subsystem, by the plurality of processor cores. A set of at least two criteria is associated to each access request in the plurality of access requests. The criteria are dynamically assigned. The requests are organized in two vectors and a stack. The request is granted, based on data in the two vectors and the stack.

The block diagram 400 can include a multicore processor 410. The multicore processor can comprise two or more processors, where the two or more processors can include homogeneous processors, heterogeneous processors, etc. In the block diagram, the multicore processor can include N processor cores such as core 0 420, core 1 440, core N−1 460, and so on. Each processor can comprise one or more elements. In embodiments, each core, including cores 0 through core N−1 can include a physical memory protection (PMP) element, such as PMP 422 for core 0; PMP 442 for core 1, and PMP 462 for core N−1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 424 for core 0, MMU 444 for core 1, and MMU 464 for core N−1. The memory management units can translate virtual addresses used by software running on the cores to physical memory addresses with caches, the share memory system, etc.

The processor cores associated with the multicore processor 410 can include caches such as instruction caches and data caches. The caches, which can comprise level 1 (L1) caches, can include an amount of storage such as 16 KB, 32 KB, and so on. The caches can include an instruction cache I$ 426 and a data cache D$ 428 associated with core 0; an instruction cache I$ 446 and a data cache D$ 448 associated with core 1; and an instruction cache I$ 466 and a data cache D$ 468 associated with core N−1. In addition to the level 1 instruction and data caches, each core can include a level 2 (L2) cache. The level 2 caches can include L2 cache 430 associated with core 0; L2 cache 450 associated with core 1; and L2 cache 470 associated with core N−1. The cores associated with the multicore processor 410 can include further components or elements. The further elements can include a level 3 (L3) cache 412. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 414. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 416. The JTAG can provide a boundary within the cores of the multicore processor. The JTAG can enable fault information to a high precision. The high-precision fault information can be critical to rapid fault detection and repair.

The multicore processor 410 can include one or more interface elements 418. The interface elements can support standard processor interfaces such as an Advanced eXtensible Interface (AXI™) such as AXI4™, an ARM™ Advanced eXtensible Interface (AXI™) Coherence Extensions (ACE™) interface, an Advanced Microcontroller Bus Architecture (AMBA™) Coherence Hub Interface (CHI™), etc. In the block diagram 400, the interface elements can be coupled to the interconnect. The interconnect can include a bus, a network, and so on. The interconnect can include an AXI™ interconnect 480. In embodiments, the network can include network-on-chip functionality. The AXI™ interconnect can be used to connect memory-mapped “master” or boss devices to one or more “slave” or worker devices. In the block diagram 400, the AXI interconnect can provide connectivity between the multicore processor 410 and one or more peripherals 490. The one or more peripherals can include storage devices, networking devices, and so on. The peripherals can enable communication using the AXI™ interconnect by supporting standards such as AMBA™ version 4, among other standards.

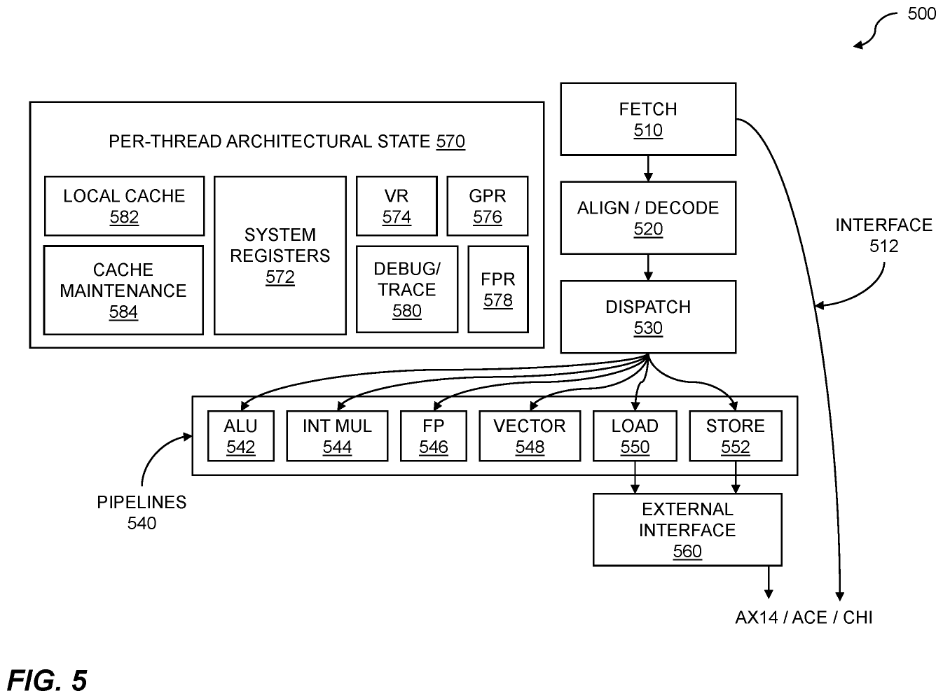

FIG. 5 is a block diagram for a pipeline. The use of one or more pipelines associated with a processor architecture can greatly enhance processing throughput. The processor architecture can be associated with one or more processor cores. The processing throughput can be increased by execution of multiple operations in parallel. The use of one or more pipelines supports coherency management, where the coherency management is enabled by access request dynamic multilevel arbitration. A plurality of processor cores is accessed. The plurality of processor cores is coupled to a memory subsystem. A plurality of access requests is generated, within the plurality of processor cores coupled to the memory subsystem, by the plurality of processor cores. A set of at least two criteria is associated to each access request in the plurality of access requests. The criteria are dynamically assigned. The requests are organized in two vectors and a stack. The request is granted, based on data in the two vectors and the stack. The vectors are organized as linear vectors. The stack is organized as a push-pop stack.

The FIG. 500 shows a block diagram of a pipeline such as a processor core pipeline. The blocks within the block diagram can be configurable in order to provide varying processing levels. The varying processing levels can be based on processing speed, bit lengths, and so on. The block diagram 500 can include a fetch block 510. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 512. The interface can include a standard interface such as one or more industry standard interfaces. The interfaces can include an Advanced eXtensible Interface (AXI™), an ARM™ Advanced eXtensible Interface (AXI™) Coherence Extensions (ACE™) interface, an Advanced Microcontroller Bus Architecture (AMBA™) Coherence Hub Interface (CHI™), etc.

The block diagram 500 includes an align and decode block 520. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decode packets. The decode packets can be used in the pipeline to manage execution of operations. The system block diagram 500 can include a dispatch block 530. The dispatch block can receive decoded instruction packets from the align and decode block. The decode instruction packets can be used to control a pipeline 540, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 542, integer multiplier pipelines 544, floating-point unit (FPU) pipelines 546, vector unit (VU) pipelines 548, and so on. The dispatch unit can further dispatch instructions to pipes that can include load pipelines 550, and store pipelines 552. The load pipelines and the store pipelines can access storage such as the common memory using an external interface 560. The external interface can be based on one or more interface standards such as the Advanced eXtensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 570. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 572. The system registers can be associated with individual processors, a system comprising multiple processors, and so on. The system registers can include exception and interrupt components, counters, etc. The per-thread architectural state can include further registers such as vector registers (VR) 574, general purpose registers (GPR) 576, and floating-point registers 578. These registers can be used for vector operations, general purpose (e.g., integer) operations, and floating-point operations, respectively. The per-thread architectural state can include a debug and trace block 580. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 582. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 584. The cache maintenance state can include maintenance needed, maintenance pending, and maintenance complete states, etc.

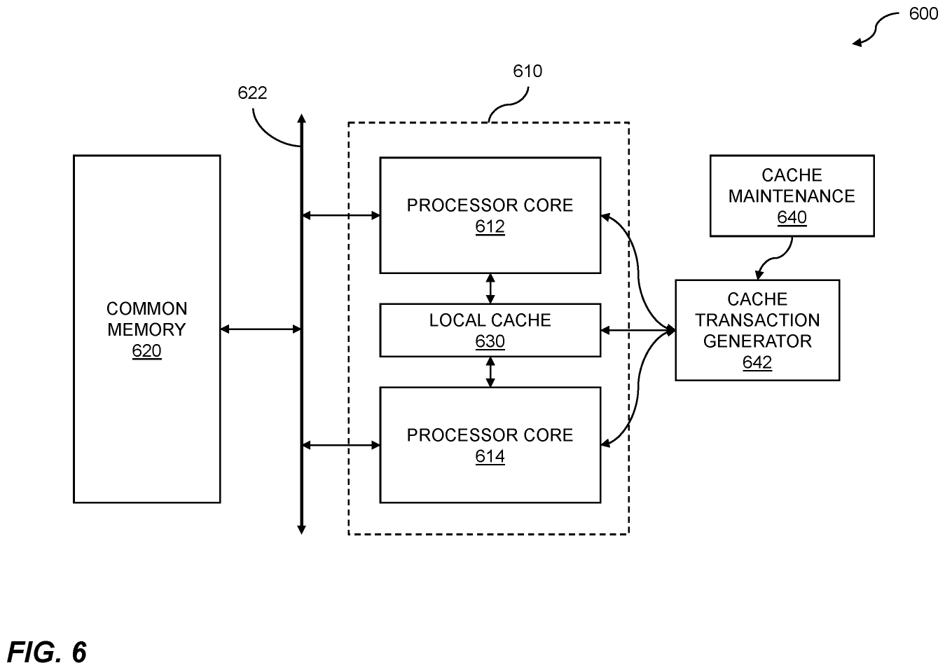

FIG. 6 is a system block diagram illustrating processor cores with processor request arbitration. Described previously and throughout, one or more processor cores can be coupled to a local cache. Processor cores can be arranged into groupings of two or more processor cores. The local cache can be loaded with data from a source such as a common shared memory. The processor cores that are coupled to the local cache can process the data within the local cache, causing the data to become “dirty” or changed from the contents of the shared memory. Since multiple groupings of processor cores can each be coupled to their own local caches, the problem of incoherency between the contents of the shared memory and the local caches becomes highly complex. To resolve the coherency challenges, one or more coherency management operations can be applied to the data within the local caches and within the shared memory. An operation such as a “snoop” operation can examine shared memory and cache access operations so that the access operations can be ordered, and storage access hazards can be avoided. Memory access hazards can include write before read, read before write, and so on. The coherency management operations enable coherency management based on access request dynamic multilevel arbitration. A plurality of processor cores is accessed, wherein the plurality of processor cores is coupled to a memory subsystem. A plurality of access requests is generated, within the plurality of processor cores coupled to the memory subsystem, by the plurality of processor cores. A set of at least two criteria is associated to each access request in the plurality of access requests, wherein the criteria are dynamically assigned. The requests are organized in two vectors and a stack. The request is granted, based on data in the two vectors and the stack.

A system block diagram 600 of processor cores with processor request arbitration is shown. A multicore processor 610 can include a plurality of processor cores. The processor cores can include homogeneous processor cores, heterogeneous cores, and so on. In the system block diagram 600, two processor cores are shown, processor core 612 and processor core 614. The processor cores can be coupled to a common memory 620. The common memory can be shared by a plurality of multicore processors. The common memory can be coupled to the plurality of processor cores through a coherent network-on-chip 622. The network-on-chip can be colocated with the plurality of processor cores within an integrated circuit or chip, an application-specific integrated circuit (ASIC), a field programmable gate array (FPGA), and so on. The network-on-chip can be used to interconnect the plurality of processor cores and other elements within a system-on-chip (SoC) architecture. The network-on-chip can support coherency between the common memory 620 and one or more local caches (described below) using coherency transactions. In embodiments, the cache coherency transactions can enable coherency among the plurality of processor cores, one or more local caches, and the memory. The cache coherency can be accomplished based on coherency messages, cache misses, and the like.

The system block diagram 600 can include a local cache 630. The local cache can be coupled to a grouping of two or more processor cores within a plurality of processor cores. The local cache can include a multilevel cache. In embodiments, the local cache can be shared among the two or more processor cores. The cache can include a multiport cache. In embodiments, the grouping of two or more processor cores and the shared local cache can operate using local coherency. The local coherency can indicate to processors associated with a grouping of processors that the contents of the cache have been changed or made “dirty” by one or more processors within the grouping. In embodiments, the local coherency is distinct from the global coherency. That is, the coherency maintained for the local cache can be distinct from coherency between the local cache and the common memory, coherency between the local cache and one or more further local caches, etc.

The system block diagram 600 can include a cache maintenance element 640. The cache maintenance element can maintain local coherency of the local cache, coherency between the local cache and the common memory, coherency among local caches, and so on. The cache maintenance can be based on issuing cache transactions. In the system block diagram 600, the cache transaction can be provided by a cache transaction generator 642. In embodiments, the cache coherency transactions can enable coherency among the plurality of processor cores, one or more local caches, and the memory. The contents of the caches can become “dirty” by being changed. The cache contents changes can be accomplished by one or more processors processing data within the caches, by changes made to the contents of the common memory, and so on. In embodiments, the cache coherency transactions can be issued globally before being issued locally. Issuing the cache coherency transactions globally can ensure that the contents of the local caches are coherent with respect to the common memory. Issuing the cache coherency transactions locally can ensure coherency with respect to the plurality of processors within a given grouping. In embodiments, the cache coherency transactions that are issued globally can complete before cache coherency transactions are issued locally. The completion of the coherency transaction issued globally can include a response from the coherent network-on-chip.

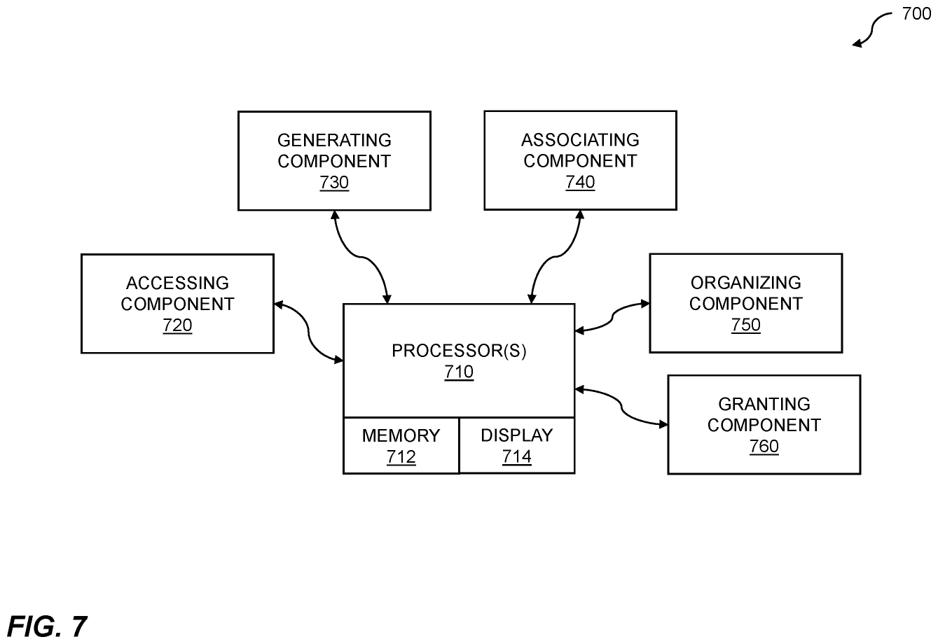

FIG. 7 is a system diagram for processor request arbitration, where the processor request arbitration is enabled by access request dynamic multilevel arbitration. The system can comprise an apparatus for processor request arbitration. The apparatus can be based on semiconductor logic. The system 700 can include one or more of processors, memories, cache memories, displays, and so on. The system 700 can include one or more processors 710. The processors can include standalone processors within integrated circuits or chips, processor cores in FPGAs or ASICs, custom integrated circuits, and so on. The one or more processors 710 are coupled to a memory 712, which stores operations. The memory can include one or more of local memory, cache memory, system memory, shared memory, etc. The system 700 can further include a display 714 coupled to the one or more processors 710. The display 714 can be used for displaying data, instructions, operations, vector contents, push-pop stack contents, snoop requests, snoop responses, and the like. The operations can include operations such as Advanced eXtensible Interface (AXI) Coherence Extensions (ACE) cache transactions, Advanced Microcontroller Bus Architecture (AMBA™) Coherence Hub Interface (CHI™) transactions, etc. In embodiments, one or more processors 710 are coupled to the memory 712, wherein the one or more processors, when executing the instructions which are stored, are configured to: access a plurality of processor cores, wherein the plurality of processor cores is coupled to a memory subsystem; generate a plurality of access requests, within the processor cores coupled to the memory subsystem, by the plurality of processor cores; associate a set of at least two criteria to each access request in the plurality of access requests, wherein the criteria are dynamically assigned; organize the requests in two vectors and a stack; and grant a request, based on data in the two vectors and the stack.

The system 700 can include an accessing component 720. The accessing component 720 can access a plurality of processor cores. The processor cores can be accessed within one or more chips, FPGAs, ASICs, etc. In embodiments, the processor cores can include RISC-V™ processor cores. In the system 700, the plurality of processor cores is coupled to a memory subsystem. The memory subsystem can include shared memory, cache memory, a multilevel cache memory such as level 1 (L1), level 2 (L2), and level 3 (L3) cache memory, and so on. The L1 cache memory can include a local cache coupled to groupings of two or more processor cores. In embodiments, the plurality of processor cores comprises a coherency domain. The coherency can include coherency among the processor cores, the local caches, the shared memory, etc. The coherency between the shared memory and one or more local cache memories can be accomplished using cache maintenance operations (CMOs), described previously.

The system 700 can include a generating component 730. The generating component 730 can generate a plurality of access requests, within the plurality of processor cores coupled to the memory subsystem, by the plurality of processor cores. In embodiments, two or more processor cores within the plurality of processor cores generate access requests for the memory subsystem coupled to the plurality of processor cores. The access requests for the memory subsystem can include read or load operations, write or store operations, etc. The generated access requests can result based on cache misses to local cache, thereby requiring the memory access operations being generated for the shared memory. In embodiments, each processor of the plurality of processor cores accesses a memory subsystem such as a common memory through a coherent network-on-chip (NoC). The common memory can include on-chip memory, off-chip memory, etc. The coherent network-on-chip comprises a global coherency. The access requests can be generated by the processors as the processors are executing code, instructions, operations, etc. The processors can be executing substantially similar code or substantially different code. The processors can be performing operations on a single data set, a plurality of data sets, etc. In embodiments, multiple access requests can be made in a single processor cycle. For memory access requests, the access requests can be made to substantially similar memory addresses, adjacent address, diverse addresses, and the like. In embodiments, only one memory access request can be serviced in a single processor cycle. The executing only one memory access request prevents memory access contention conflicts.

The system 700 can include an associating component 740. The associating component 740 can associate a set of at least two criteria to each access request in the plurality of access requests, wherein the criteria are dynamically assigned. The criteria can include a number of requests to a memory location or cache line, a size of a request, an order of execution, and so on. The criteria can be based on an objective function. In embodiments, a first criterion of the at least two criteria can be an age-based, or age-ordering, criterion. The age-based criterion can be based on a technique or algorithm such as a least recently used (LRU) algorithm, a pseudo-LRU algorithm, and so on. In other embodiments, a second criterion of the at least two criteria can be a “data ready” criterion. The second criterion can indicate that data is available for loading or storing, that higher priority accesses have been executed, that data is available in a cache, and the like. In embodiments, “data ready” indicates that resultant data for a particular access request is available. The particular access request can access data in a local cache, a shared cache such as a multilevel cache, a shared memory, a common memory, etc. The linear vectors can contain various types of information.

The system 700 can include an organizing component 750. The organizing component 750 can organize the requests in two vectors and a stack. The organizing the requests into the two vectors and the stack can contain access requests, criteria, and so on. More than one access request can be generated by the plurality of processor cores. In embodiments, multiple access requests are made in a single processor cycle. The access request can be generated by code executing on the plurality of processor cores. The vectors can be organized as various types of vectors. In embodiments, the vectors can be organized as linear vectors. The linear vectors can be stored in a register file, in local storage such as a local cache, and the like. In embodiments, a first linear vector can contain access request inputs. The access request inputs can include memory access requests generated by the plurality of processor cores. The access requests can be placed into the first linear vector in the order in which the requests are received. The order in which the access requests are received can comprise an access request history. In embodiments, the access request history can include a first criterion. The first linear vector can be organized. In embodiments, a first criterion can be used to organize the first linear vector. The organizing the first linear vector can include grouping access requests that access a particular address, adjacent addresses, etc.

Discussed above, the second criterion of the at least two criteria can be a “data ready” criterion. In embodiments, the second criterion can control execution of the requests. In embodiments, the stack can be organized as a push-pop stack. In a push-pop stack, the most recently added or “pushed” item is the first item to be removed or “popped” from the stack. The stack can include various types of information associated with access requests. In embodiments, the push-pop stack can contain indices into the first linear vector. The indices can include pointers, addresses, etc. to elements (e.g., memory access requests) within the first linear vector. In embodiments, an oldest access request can be at the bottom of the push-pop stack. The oldest access request can be at the bottom of the stack because it was pushed onto the stack first. In other embodiments, a newest access request can be at the top of the push-pop stack. The newest access request can be at the top of the stack because it was the most recent request added to the stack.

The system 700 can include a granting component 760. The granting component 760 can grant the request, based on data in the two vectors and the stack. The request can include an access request obtained from the two linear vectors and the push-pop stack. The request can include a read or load, a write or store, a read-modify-write operation, and so on. The granting can be based on an order of execution, a priority or precedence of execution, and so on. The access requests can be ranked. The push-pop stack can be scanned to identify access requests to executing. In embodiments, the push-pop stack can be scanned from top to bottom. Recall that the second linear vector can contain a secondary criterion that can enable the granting a request. The second criterion can enable the granting a request based on a data ready criterion. The data ready criterion can indicate that data is available in a local cache or other storage. The data ready criterion can indicate that a cache line is available to meet a data access request. The first criteria can include that an active request is present. The stack is organized as a push-pop stack. The purpose of the push-pop stack is to organize requests in time such that the arbitration logic can prioritize requests which are now “ready” based on a second criterion, such as the second criterion of the data for the request being ready. The request is granted, based on data in the two vectors and the stack. Access request history comprises a first criterion. A second criterion enables the granting a request. A second criterion of the at least two criteria is a “data ready” criterion. If more than one active request (first criterion) is “data ready” (second criterion), then the older active request is selected, based on the order contained in the push-pop stack. In embodiments, the access requests can result from cache misses. The cache misses can include cache misses to one or more local caches coupled to processor cores, shared caches such as a shared multilevel cache, and so on. In embodiments, the granting a request results in a cache line fill for a cache miss.

The system 700 can include a computer program product embodied in a non-transitory computer readable medium for processor request arbitration, the computer program product comprising code which causes one or more processors to generate semiconductor logic for: accessing a plurality of processor cores, wherein the plurality of processor cores is coupled to a memory subsystem; generating a plurality of access requests, within the processor cores coupled to the memory subsystem, by the plurality of processor cores; associating a set of at least two criteria to each access request in the plurality of access requests, wherein the criteria are dynamically assigned; organizing the requests in two vectors and a stack; and granting a request, based on data in the two vectors and the stack.

In further embodiments, the system 700 can include an apparatus for processor request arbitration comprising: a plurality of processor cores, wherein the plurality of processor cores is coupled to a memory subsystem; two vectors and a stack coupled between the plurality of processor cores and the memory subsystem, wherein the two vectors and the stack enable access arbitration comprising: generating a plurality of access requests, within the processor cores coupled to the memory subsystem, by the plurality of processor cores; associating a set of at least two criteria to each access request in the plurality of access requests, wherein the criteria are dynamically associated; organizing the requests in the two vectors and the stack; and granting a request, based on data in the vectors and the stack.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for request arbitration comprising:
accessing a plurality of processor cores, wherein the plurality of processor cores is coupled to a memory subsystem;
generating a plurality of access requests, within the processor cores coupled to the memory subsystem, by the plurality of processor cores;
associating a set of at least two criteria to each access request in the plurality of access requests, wherein the criteria are dynamically assigned;
organizing the requests in two vectors and a stack; and
granting a request, based on data in the two vectors and the stack.

2. The method of claim 1 wherein multiple access requests are made in a single processor cycle.

3. The method of claim 2 wherein only one access request is serviced in a single processor cycle.

4. The method of claim 1 wherein the vectors are organized as linear vectors.

5. The method of claim 4 wherein a first linear vector contains access request inputs.

6. The method of claim 5 wherein access request history comprises a first criterion.

7. The method of claim 5 wherein the stack is organized as a push-pop stack.

8. The method of claim 7 wherein the push-pop stack contains indices into the first linear vector.

9. The method of claim 8 wherein an oldest access request is at the bottom of the push-pop stack.

10. The method of claim 9 wherein a newest access request is at the top of the push-pop stack.

11. The method of claim 10 wherein the push-pop stack is scanned from top to bottom.

12. The method of claim 7 wherein a second linear vector contains a secondary criterion.

13. The method of claim 12 wherein a first criterion is used to organize the first linear vector.

14. The method of claim 13 wherein the second criterion enables the granting a request.

15. The method of claim 1 wherein the access requests result from cache misses.

16. The method of claim 15 wherein the granting a request results in a cache line fill for a cache miss.

17. The method of claim 1 wherein a first criterion of the at least two criteria is an age-based criterion.

18. The method of claim 17 wherein a second criterion of the at least two criteria is a “data ready” criterion.

19. The method of claim 18 wherein “data ready” indicates that resultant data for a particular access request is available.

20. The method of claim 1 wherein each processor within the plurality of processor cores is coupled to a dedicated local cache.

21. The method of claim 20 wherein the dedicated local cache is included in a coherency domain.

22. A computer program product embodied in a non-transitory computer readable medium for processor request arbitration, the computer program product comprising code which causes one or more processors to generate semiconductor logic for:
accessing a plurality of processor cores, wherein the plurality of processor cores is coupled to a memory subsystem;
generating a plurality of access requests, within the processor cores coupled to the memory subsystem, by the plurality of processor cores;
associating a set of at least two criteria to each access request in the plurality of access requests, wherein the criteria are dynamically assigned;
organizing the requests in two vectors and a stack; and
granting a request, based on data in the two vectors and the stack.

23. An apparatus for processor request arbitration comprising:
a plurality of processor cores, wherein the plurality of processor cores is coupled to a memory subsystem;
two vectors and a stack coupled between the plurality of processor cores and the memory subsystem, wherein the two vectors and the stack enable access arbitration comprising:
generating a plurality of access requests, within the processor cores coupled to the memory subsystem, by the plurality of processor cores;
associating a set of at least two criteria to each access request in the plurality of access requests, wherein the criteria are dynamically associated;
organizing the requests in the two vectors and the stack; and
granting a request, based on data in the vectors and the stack.
